(19) United States
(12) Patent Application Publication
(10) Pub. No.: US 2016/0114334 A1
(43) Pub. Date: Apr. 28, 2016

(54) MODULAR MATERIAL PROCESSING APPARATUS

(71) Applicant: Terex GB Limited, Dungannon (GB)

(72) Inventors: Johnston Patterson, Moira (GB); Paul McWilliams, Magherafelt (GB)

(21) Appl. No.: 14/921,138

(22) Filed: Oct. 23, 2015

(30) Foreign Application Priority Data
Oct. 24, 2014 (GB) 1418988.0

(51) Int. Cl. B03B 9/02; B02C 23/08; B03B 5/34

(52) U.S. Cl. CPC B03B 9/02; B03B 5/34; B02C 23/08

(57) ABSTRACT

A material processing apparatus comprising a plurality of interconnectable modules, each module comprising a frame and at least one material processing device, for example a hydraulic classifier, and at least one ancillary component, for example a hydrocyclone, carried by and located within the frame. The frame is shaped and dimensioned to define a peripheral boundary of the module, the material processing device(s) and ancillary component(s) being located within the peripheral boundary. When the apparatus is being stored or transported it can be disassembled into a plurality of modules that have components contained within the boundary defined by the frame, i.e. not projecting outside of the frame boundary. This facilitates storage and transport in shipping containers.

### FIELD OF THE INVENTION

The present invention relates to material processing apparatus. The invention relates particularly but not exclusively to sand classification plants.

### BACKGROUND TO THE INVENTION

Conventional sand classification plants are large static installations, which are permanent and take considerable time to install.

It would be desirable to provide material processing apparatus, such as sand classification apparatus, that is easier to install and disassemble, and which is amenable to being transported.

### SUMMARY OF THE INVENTION

A first aspect of the invention provides a material processing apparatus, especially for particulate material e.g. sand, comprising a plurality of components including at least one material processing device and at least one ancillary component, the apparatus comprising a plurality of interconnectable modules, each module comprising a frame and at least one of said components carried by and located within the frame, wherein said frame is shaped and dimensioned to define a peripheral boundary of the module, said at least one of said components being located within said peripheral boundary.

In preferred embodiments, the material processing apparatus comprises a plurality of modules, each module advantageously matching, or at least not exceeding, the size of a standard shipping container.

In some embodiments, the material processing apparatus comprises one or more material processing devices for the hydraulic classification of particles, for example sand or other aggregate matter, by size, weight and/or density. The material processing devices may comprise one or more hydrocyclones, one or more particle classifiers, one or more pumps and one or more tanks. Each module comprises any one or more of any one or more of said material processing devices.

Advantageously, the modularisation of the apparatus allows it to be easily moved from site to site, conveniently in standard shipping containers, with minimal assembly and disassembly, thus resulting in less down time of the apparatus. Installation time and disassembly time is relatively short, not least because less civil engineering work is required for installation in comparison with a conventional plant. Advantageously, each module will be pre-wired and pre-plumbed.

A second aspect of the invention provides a particulate material classification plant comprising the apparatus of the first aspect of the invention.

Preferred features are recited in the dependent claims.

Further advantageous aspects of the invention will become apparent to those ordinarily skilled in the art upon review of the following description of a specific embodiment and with reference to the accompanying drawings.

### BRIEF DESCRIPTION OF THE DRAWINGS

An embodiment of the invention is now described by way of example and with reference to the accompanying drawings in which:

FIG. 1 is a front perspective view of a material processing apparatus embodying the invention;

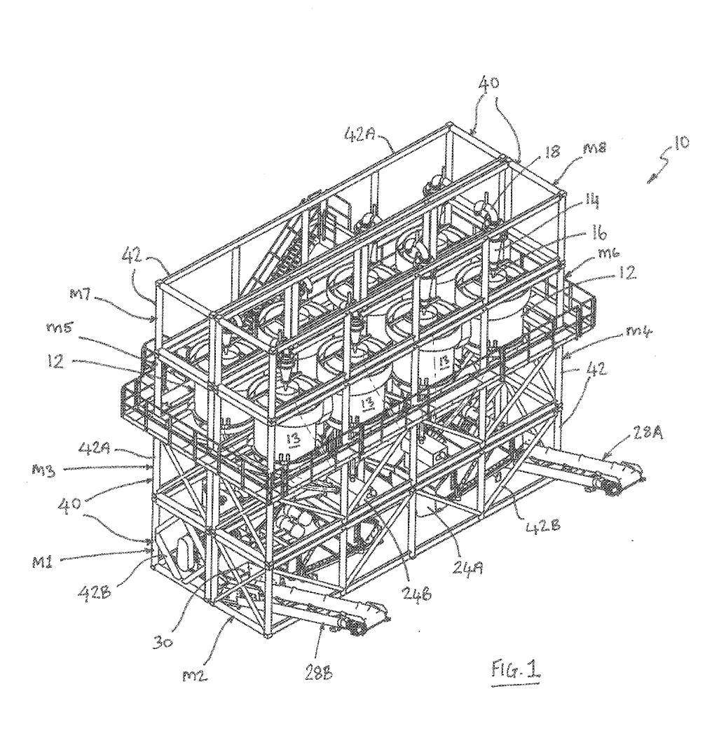

FIG. 2 is a rear perspective view of the material processing apparatus of FIG. 1;

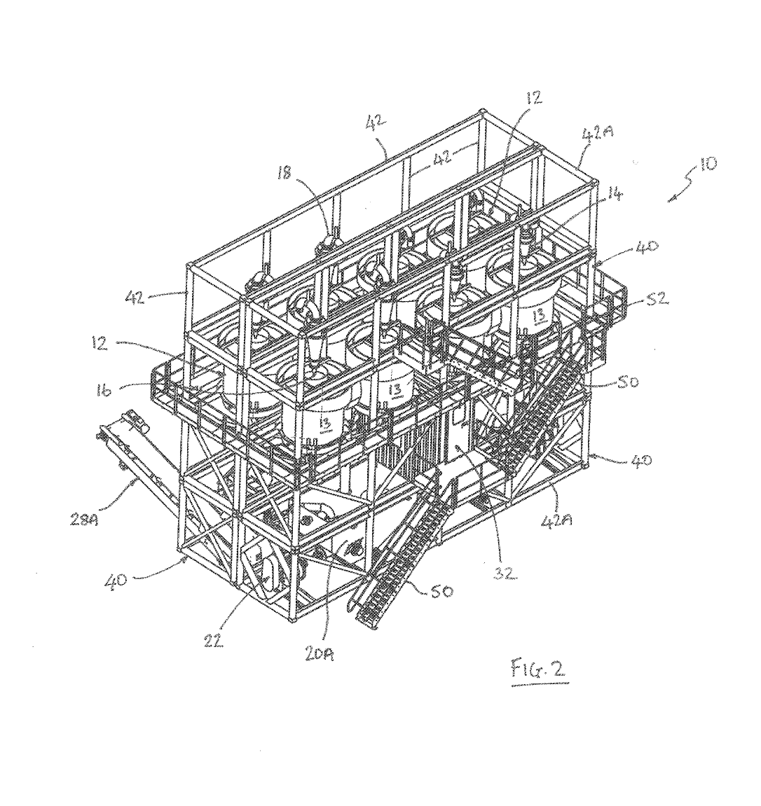

FIG. 3 is a plan view of the material processing apparatus of FIG. 1;

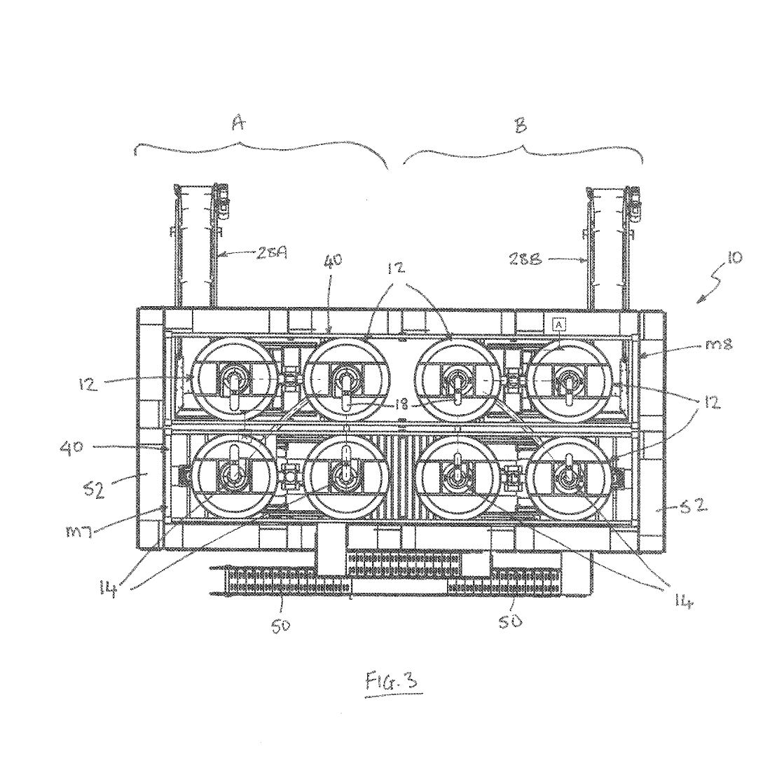

FIG. 4 is a side view of the material processing apparatus of FIG. 1; and

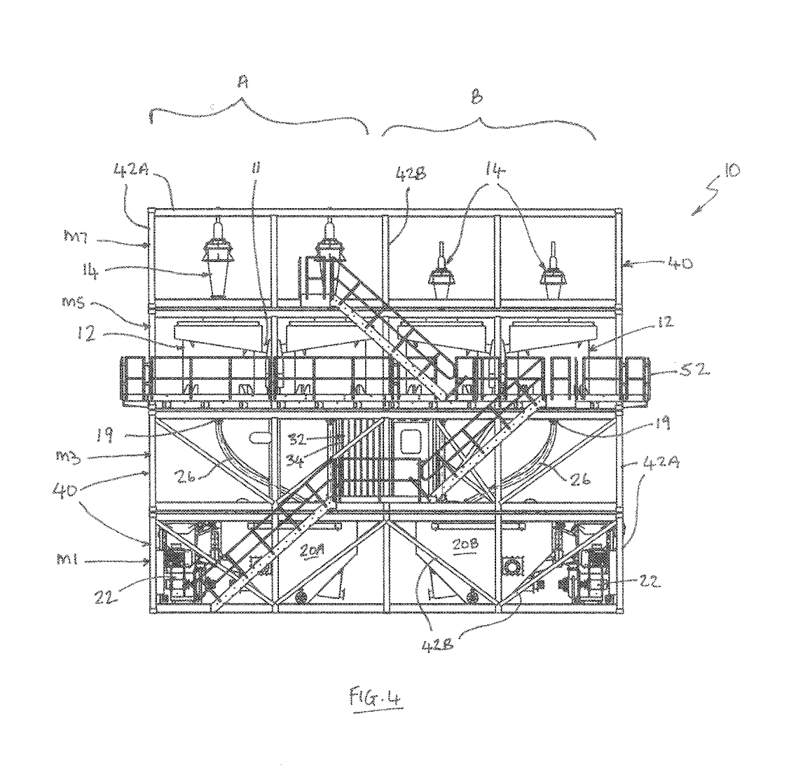

FIG. 5 is an end view of the material processing apparatus of FIG. 1;

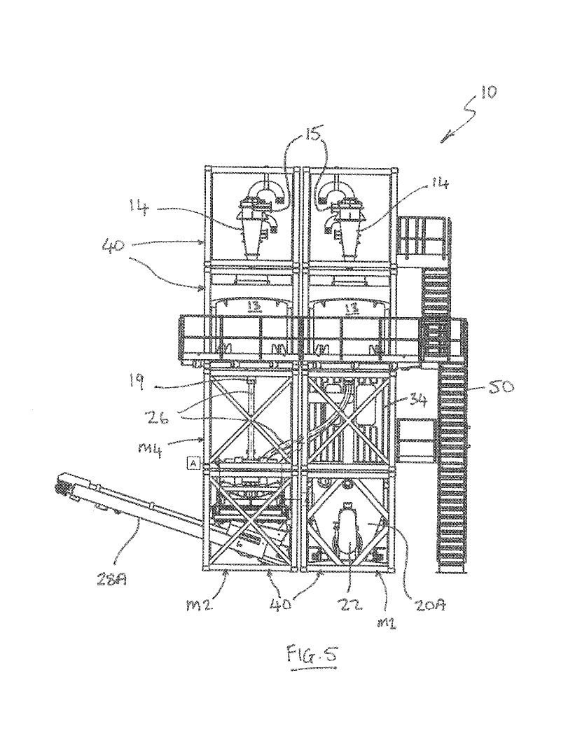

### DETAILED DESCRIPTION OF THE DRAWINGS

Referring now to the drawings, there is shown, generally indicated as 10, a material processing apparatus embodying the invention. In general, the material processing apparatus may be configured to perform any one or more of a plurality of processes, such as feeding, screening, separating, crushing, waste recycling or demolition and/or washing, on one or more types of aggregate or other material especially particulate material, for example rocks, stones, gravel, sand and/or soil, or any other material that is quarried, mined, excavated or recycled. To this end, the apparatus may include one or more material processing device configured to perform one or more of the foregoing processes. In addition, the apparatus may include one or more ancillary components that are co-operable with the material processing device(s) and/or each other to allow the overall apparatus to perform its function.

In the illustrated embodiment, the material processing apparatus 10 is intended to perform separation of particulate material, for example sand. In particular the apparatus 10 is intended to perform classification, and in particular hydraulic classification, of particulate material by particle size, weight and/or density. Accordingly, the apparatus 10 may be referred to as a hydraulic classification apparatus. In typical embodiments the material processing apparatus is static once installed and may therefore be said to be a material processing plant.

To perform hydraulic classification, the preferred apparatus 10 includes at least one, but typically a plurality of, hydraulic classifiers 12. In the illustrated embodiment, the classifiers 12 are sand classifiers. Each classifier 12 comprises a tank 13 having an inlet 17 for receiving slurry for classification, and a respective outlet 19 (only one shown) for each grade of material to be output. The tank 13 also has an inlet (not shown) for receiving pressurised liquid (typically water) for performing hydraulic classification of the slurry. The liquid typically comes from a source, e.g. a pond or reservoir, that is external to the apparatus 10. In preferred embodiments, the tank 13 is a flat-bottomed tank. The classifiers 12 may be of conventional construction, for example being of a type commonly known as flat-bottomed classifiers.

In preferred embodiments, the apparatus 10 also includes at least one, but typically a plurality of hydrocyclones 14. The hydrocyclones 14 are configured to deliver particulate material to the classifiers 12, typically from above. Preferably, a respective one of the hydrocyclones 14 is provided to deliver particulate material to a respective one of the classifiers 12 (vie the respective inlet 17), although in alternative embodiments (not illustrated), more than one hydrocyclone may be provided for each classifier 12. The hydrocyclones 14 may be of conventional construction.

The apparatus 10 includes at least one storage tank 20 for storing slurry (particulate material, e.g. sand, mixed with liquid, typically water) prior to being processed by the hydrocyclones 14 and classifiers 12. In typical embodiments, the hydrocyclones 14 and classifiers 12 are arranged into to at least two groups, each group having at least one classifier 12 and at least one associated hydrocyclone 14. Preferably, a respective storage tank 20 is provided for each group. The groups may be arranged in series such that processed slurry output from at least one of the groups is fed into the storage tank 20 of another of the groups. In the illustrated embodiment, there is a first group A comprising four classifiers 12 and respective hydrocyclones 14, and a second group B comprising four classifiers 12 and respective hydrocyclones 14. Storage tank 20A is provided for group A, and storage tank 20B is provided for group B. In this example, some of the processed slurry output by the classifiers 12 of group A is fed to the storage tank 20A for provision to group B, in particular to the hydrocyclones 14 of group B. Some of the processed slurry output by the classifiers 12 of group B is fed to the storage tank 20B, and may be treated as waste or provided to an external material processing apparatus (not shown).

In order to feed slurry from the storage tank(s) 20 to the separation devices, one or more pumps 22 are provided. Any suitable conventional pumps may be used for this purpose. Typically, a respective pump 22 is provided for each storage tank 20A, 20B.

The hydraulic classifiers 12 and hydrocyclones 14 may each be regarded as material processing devices for performing separation of particulate material, e.g. sand. The hydrocyclones 14 of group A are usually fed slurry from an external source (not shown) and the hydrocyclones 14 of group B are fed with slurry from the storage tank 20A under the action of the respective pump 22. A respective pipe (not shown) is provided between the tank 20A and inlet 15 of the respective hydrocyclone 14 for this purpose.

The action of the hydrocyclone 14 separates the particles such that the larger, heavier and/or more dense particles (still in slurry form, i.e. mixed with liquid) are output from a lower outlet 16 (known as the underflow) to the respective classifier 12. The smaller, lighter and/or less dense particles exit the hydrocyclone 14 via an upper outlet 18 (known as the overflow). The overflow from the hydrocyclones 14 is typically regarded as waste and may be directed from the apparatus 10 to any desired destination (not shown), e.g. a pond or treatment plant. The hydrocyclones 14 perform a pre-conditioning of the slurry before reaching the respective classifier 12.

The classifiers 12 perform a further separation of the particles received from the hydrocyclones 14 into multiple grades, the separation process commonly being referred to as classification. In the illustrated embodiment, each classifier 12 separates the particles between a first grade (which are relatively large, heavy and/or dense) and a second grade (which are relatively small, light and/or less dense). The first grade particles sink to the bottom of the tank 13 and are output from the tank 13 via outlet 19.

The particles exiting the classifier 12 are still in slurry form and so the apparatus 10 includes at least one de-watering apparatus 24 for separating the particles from the liquid. Any suitable conventional de-watering apparatus may be used for this purpose. In the illustrated embodiment, a respective de-watering apparatus 24A, 24B is provided for each group of hydrocyclones 14 and classifiers 12. The slurry exiting the classifiers 12 via outlet 19 is fed to the respective de-watering apparatus 24A, 24B. To this end, a respective pipe 26 is provided between the respective outlet 19 and respective de-watering apparatus 24A, 24B.

In each classifier 12, the second grade material rises to the top of the tank 13 from where it may be gathered and directed (e.g. by a weir device) to a second tank outlet 11. In the illustrated embodiment, the second grade material exiting the tanks 13 of group A via the second outlet 11 is fed to the storage tank 20A. Respective pipes (not shown) are provided for this purpose.

Transfer of slurry from the classifiers 12 to the storage tanks or de-waterers is typically effected by gravity.

The apparatus 10 may include one or more conveyors 28 for delivering the classified and de-watered particulate material, e.g. sand, to a desired destination e.g. a stockpile (not shown). In the illustrated embodiment a respective conveyor 28A, 28B is provided for each group of hydrocyclones/classifiers. The respective conveyor 28 typically has its feed end 30 located at the output of the respective de-watering apparatus 24A, 24B to receive the de-watered particulate material. The body of each conveyor 28 projects from the apparatus 10. Any suitable conventional conveyor may be used, and may be fixed, movable or foldable as desired.

In use of the preferred embodiment, slurry is supplied from an external source to the hydrocyclones 14 of group A for pre-conditioning. The pre-conditioned slurry is fed to the respective classifiers 12 of group A. The first grade material produced by the classifiers 12 is fed to the respective de-waterer 24A whereupon it is de-watered and supplied to conveyor 28A for delivery to the desired destination. The second grade material produced by the classifiers 12 of group A is fed to the storage tank 20A whereupon it is fed to the hydrocyclones 14 of group B for pre-conditioning. The pre-conditioned slurry is fed to the respective classifiers 12 of group B. The first grade material produced by the classifiers 12 is fed to the respective de-waterer 24B whereupon it is de-watered and supplied to conveyor 28B for delivery to the desired destination.

The respective performance characteristics of the respective hydrocyclones and classifiers of each group are selected to be complementary so that hydrocyclones and classifiers of each group are suited to processing the material that is provided to them and to produce material of the required grade. For example, in the illustrated embodiment, the hydrocyclones and classifiers of group B are configured to process material that is smaller, lighter and/or less dense than the material that the hydrocyclones and classifiers of group B are configured to process. As a result, each group produces a different grade of particulate material.

In typical embodiments, the apparatus 10 includes a control centre 32 with electrical, hydraulic and/or pneumatic control equipment (not shown) for controlling the components of the apparatus 10. The control centre 32 may be located in a room defined by an enclosure 34.

The apparatus 10 comprises a plurality of inter-connectable modules. In the illustrated embodiment, the apparatus 10 comprises eight modules M1-M8. In alternative embodiments, more or fewer modules may be provided depending on the nature and capacity of the apparatus. In comparison with a conventional sand classification plant with similar processing capacity, the classifiers 12 of apparatus 10 are smaller in order to fit into the modules, and are therefore more numerous.

Each module M1-M8 comprises a support frame 40 within which one or more components of the apparatus 10 are located. The respective components are mounted on other otherwise carried by the frame 40 using any one or more conventional fixing and/or mounting devices (not shown), e.g. screws, bolts, welds, brackets and/or other supports. Advantageously, the frame 40 defines the peripheral boundary of the module M1-M8 such that the components located in the frame 40 do not project beyond its peripheral boundary. In preferred embodiments the frame 40 provides a cage around its respective component(s). Preferably, the frame 40 is substantially cuboid in shape.

Typically, the frame 40 comprises a plurality of elongate frame members 42 connected together to define the peripheral boundary of the module. The frame members 42 may include edge frame members 42A defining the edges of the boundary and optionally one or more support frame members 42B for supporting the edge frame members 42A.

For convenience, it is preferred that each module M1-M8, and therefore the frame 40 of each module, of the apparatus 10 is the same size and shape. The frame 40 may be formed from any suitable rigid material, typically metal, for example steel.

Advantageously, the frame 40 (and therefore the module) is sized to match, or at least not to exceed, the size of a standard shipping container (not shown), preferably shipping containers conforming to ISO standard 6346, which may for example have a width of 2.44 m, a height of 2.59 m and a length of 6.1 or 12.19 m. As a result, each module M1-M8 is shaped and dimensioned to fit into a standard shipping container, preferably such that the frame 40 substantially matches the internal dimensions of the shipping container.

In preferred embodiments, each module each module M1-M8 is releasably interconnectable, mechanically, to one or more other modules M1-M8 located at either or both sides, either or both ends, above or below the module. Accordingly, the apparatus 10 can be constructed by assembling the modules M1-M8 in an array in which modules may be located side-by-side, end-on-end and/or stacked on top of one another as required. For example, in the illustrated embodiment, the apparatus 10 comprises four stacked layers, each layer comprising two modules side-by-side.

At least one, and typically a plurality of, interconnector parts (not shown) are provided on the frame 40 to allow it to be releasably connected (mechanically) to one or more other frames 40. Optionally, one or more such interconnector part is provided at each side, each end, the top and the bottom of the frame 40, conveniently on the frame members 42. More typically, one or more interconnector is provided at each corner of the frame 40, especially the corners of the cuboid shape formed by the preferred frame. Typically, each interconnector part is one of a corresponding male or female part. It is preferred that the frame 40 is provided with both male and female interconnector parts positioned for interconnection with a corresponding female or male interconnector part on another frame 40. The resulting interconnectors are preferably lockable. By way of example conventional twistlock/corner casting interconnectors may be used.

One or more modules M1-M8 may include one or more components that require electrical power and/or electrical control signals, or which supply electrical power and/or may be required to carry electrical cabling for routing electrical power and/or electrical control signals to other modules. Preferably, any requisite electrical wiring is included in the module, for example being carried by the frame 40, and may terminate at one or more electrical connectors (not shown). When the modules M1-M8 are assembled, the electrical connectors of one module may be connected to corresponding electrical connectors of one or more other modules as appropriate. Optionally, electrical connector(s) are grouped together at an electrical connection station (not shown). This facilitates the electrical interconnection of modules.

One or more modules M1-M8 may include one or more components that require fluid to be supplied to them, or which supply fluid to other components, and/or may be required to carry pipework for routing fluid to other modules. The fluid may for example be pneumatic fluid, hydraulic fluid or slurry. Optionally, the requisite pipework is included in the module, for example being carried by the frame 40, and may terminate at one or more fluid connectors (not shown). When the modules M1-M8 are assembled, the fluid connectors of one module may be connected to corresponding fluid connectors of one or more other modules as appropriate. Optionally, fluid connector(s) are grouped together at a fluid connection station (not shown). This facilitates the fluid interconnection of modules. Conveniently, the fluid connection station may be located adjacent or integrated with the electrical connection station.

In typical embodiments, the apparatus 10 is assembled from one or more instances of a plurality of types of module. Each module type has a respective configuration of components located within the respective frame 40. The components may include one or more material processing device (e.g. a hydrocyclone, a hydraulic classifier, a de-waterer and/or other feeding, screening, separating, crushing, waste recycling, demolition and/or washing device), and/or one or more ancillary components (e.g. pump, conveyor, power generator, storage vessel, control unit, enclosure, connectors, wiring, cables and/or pipework). It will be understood that each module may include one or more than one instance of any one or more component, as required.

The specific configuration of each module type may vary depending on the nature of the material processing apparatus being implemented. In the illustrated embodiment, the apparatus 10 comprises the following module types:

Type 1—comprising at least one, preferably both, of the storage tanks 20A, 20B and respective pumps 22. This type may also include associated wiring, cables and/or pipework, e.g. all or part of the pipes for connecting the storage tanks 20A, 20B to the respective hydrocyclones 14 and/or classifiers 12 as required. This module may also include any power generators (e.g. electrical, hydraulic and/or pneumatic)

Type 2—comprising at least one, preferably both, of the de-waterers 24A, 24B. This type may also include associated wiring, cables and/or pipework, e.g. all or part of the pipes for connecting the de-waterers 24A, 24B to the respective storage tanks 20A, 20B. This type may also include the conveyors 28A, 28B or may at least include a space in which the conveyors can be mounted. This module may also include any power generators (e.g. electrical, hydraulic and/or pneumatic)

Type 3—comprising the control centre 32. This type may also include wiring, cables and/or pipework, e.g. electrical wiring (including wiring to and from the control centre 32), and optionally part of the pipework for connecting components in other modules. This module may also include any power generators (e.g. electrical, hydraulic and/or pneumatic).

Type 4—which may be considered as spacer module but may include wiring, cables and/or pipework, e.g. electrical wiring and/or optionally part of the pipework for connecting components in other modules.

Type 5—comprising one or more of the hydraulic classifiers 12. This type may also include associated wiring, cables and/or pipework, e.g. all or part of the pipes for connecting the classifiers 12 to the respective storage tanks 20A, 20B, de-waterer 24A, 24B and hydrocyclone 14 as applicable.

Type 6—comprising one or more of the hydrocyclones 14. This type may also include associated wiring, cables and/or pipework, e.g. all or part of the pipes for connecting the hydrocyclones 12 to the respective storage tanks 20A, 20B and classifier 12 as applicable.

Any of the types may include wiring, cables and/or pipework, e.g. electrical wiring and/or optionally part of the pipework for connecting components in other modules, as required.

In the illustrated embodiment, a type 1 module M1 and a type 2 module M2 are located side-by-side to provide the base for the apparatus 10. A type 3 module M3 and a type 4 module M4 are located side-by-side on top of the base modules M1, M2. Conveniently, module M3 is on top of module M1, and module M4 is on top of module M2. In this example, module M4 does not include any pipework of its own, but provides space through which other pipes, cables and wires can be routed, as well as providing support for the module above it. Two instances of the type 5 module M5, M6 are located side-by-side on top of the modules M3, M4. Conveniently, module M5 is on top of module M3, and module M6 is on top of module M4. Two instances of the type 6 module M7, M8 are located side-by-side on top of the modules M5, M6. Conveniently, module M7 is on top of module M5, and module M8 is on top of module M6.

The total number of classifiers 12 required by the apparatus 10 is provided collectively by modules M5 and M6. It is preferred that modules of a given type are substantially the same and so each module M5, M6 includes the same number of classifiers 12, four in this example. In each module M5, M6 the classifiers 12 are conveniently arranged in a row, preferably in the longitudinal direction. In this example, each module M5, M6 includes the same number of classifiers 12 from each group A, B (two from each in this case).

The total number of hydrocyclones 14 required by the apparatus 10 is provided collectively by modules M7 and M8. It is preferred that modules of a given type are substantially the same and so each module M7, M8 includes the same number of hydrocyclones 14, four in this example. In each module M7, M8 the hydrocyclones 14 are conveniently arranged in a row, preferably in the longitudinal direction. In this example, each module M7, M8 includes the same number of hydrocyclones 14 from each group A, B (two from each in this case).

The type 5 and 6 modules are configured so that, when located on top of one another as described, the respective hydrocyclone 14 is suitably positioned, e.g. above and preferably in line with, in relation to the respective classifier 12 to provide material to it as described.

The illustrated apparatus 10 comprises eight modules M1-M8 arranged in four stacked layers, each layer having two modules side-by-side. In alternative embodiments, more or fewer modules may be required, and may be arranged in more or fewer layers, each layer comprising one or more module (side-by-side when there is more than one). The composition of each layer, i.e. the type(s) of module(s) used is dependent on the nature of the apparatus and its required processing capacity.

In use, the apparatus 10 is installed by layer by layer, starting with the modules M1, M2 of the base layer and building the layers upwardly. Adjacent modules (at the side, above and/or below as applicable) are interconnected using the respective interconnectors. Any electrical and/or fluid interconnections between modules can be made using the respective electrical and/or fluid connectors. Optionally, at least some of the pipework, e.g. including pipe 26, may be provided separately and installed when convenient.

Optionally, one or more stairways 50 and/or walkways 52 may be removably mounted on the apparatus 10, typically at one or more outer faces of one or more of the modules M1-M8 as required. For example, the stairways 50 and/or walkways 52 may be connected to the relevant frame(s) 40 using any convenient conventional interconnectors (not shown). It will be apparent therefore that, when the apparatus is in use, some parts, e.g. walkways, stairways and conveyors, may project beyond the peripheral boundary defined by the frame. Advantageously, however, when the apparatus is being stored or transported it can be disassembled into a plurality of separate modules that have components contained within the boundary defined by the frame, i.e. not projecting outside of the frame boundary.

Disassembly is readily achieved by disconnecting the electrical, fluid and mechanical connections between the modules and deconstructing the layers module-by-module. The modules may then be inserted into a respective shipping container for storage or transport.

Preferred embodiments offer some or all of the following advantages in comparison with conventional plant: reduced requirement for civil engineering works; reduced footprint on the ground; relatively quick installation and disassembly of the apparatus; pre-wired and pre-plumbed; the apparatus can more easily be moved from site to site; the components of the apparatus are provided in modules the size of standard shipping containers to facilitate transport.

The invention is not limited to the embodiment(s) described herein but can be amended or modified without departing from the scope of the present invention.

1. A material processing apparatus comprising a plurality of components including at least one material processing device and at least one ancillary component, the apparatus comprising a plurality of interconnectable modules, each module comprising a frame and at least one of said components carried by and located within the frame, wherein said frame is shaped and dimensioned to define a peripheral boundary of the module, said at least one of said components being located within said peripheral boundary.

2. The apparatus of claim 1, wherein said frame is shaped and dimensioned to fit within a standard shipping container, preferably a shipping container conforming to ISO standard 6346, said frame preferably being shaped and dimensioned to substantially match the internal shape and dimensions of a standard shipping container.

3. The apparatus of claim 1, wherein said frame provides a cage around said at least one of said components.

4. The apparatus of claim 1, wherein said frame comprises a plurality of elongate frame members connected together to define the peripheral boundary, the frame members preferably including edge frame members defining the edges of the peripheral boundary and optionally one or more support frame members for supporting the edge frame members.

5. The apparatus of claim 1, wherein the modules are arranged in an array in which the modules are located side-by-side, end-on-end and/or stacked on top of one another.

6. The apparatus of claim 1, wherein each module is releasably mechanically interconnectable to one or more other of said modules located at any one or more of either or both sides, either or both ends, above or below the module, and wherein, preferably, at least one, and typically a plurality of, interconnector parts are provided on the frame to allow it to be releasably mechanically connected to the respective frame of one or more other module.

7. The apparatus of claim 1, wherein at least one of said modules includes electrical wiring, preferably carried by the respective frame, and wherein, preferably, said electrical wiring includes at one or more electrical connectors grouped together at an electrical connection station.

8. The apparatus of claim 1, wherein at least one of said modules includes pipework for carrying fluid to or from said at least one of said components and/or for carrying fluid through said module, the pipework preferably being carried by the respective frame, and wherein, preferably, said pipework includes one or more fluid connectors grouped together at a fluid connection station.

9. The apparatus of claim 1, comprising one or more instances of a plurality of types of module, each module type having a respective configuration of said components located within the respective frame.

10. The apparatus of claim 1, wherein said at least one material processing device comprises one or more instance of any one or more of a hydrocyclone, a hydraulic classifier, a de-waterer and/or other feeding, screening, separating, crushing, waste recycling, demolition and/or washing device.

11. The apparatus of claim 1, wherein said at least one ancillary component comprises one or more instance of any one or more of a pump, conveyor, power generator, storage vessel, control unit, enclosure, connector, wiring, cables and/or pipework.

12. The apparatus of claim 1, wherein said apparatus is a particulate material classification apparatus, and wherein said at least one material processing device comprises at least one hydraulic classifier, and wherein, preferably, said at least one material processing device includes a respective hydrocyclone for supplying material to said at least one hydraulic classifier.

13. The apparatus of claim 12, comprising one or more instances of a plurality of types of module, each module type having a respective configuration of said components located within the respective frame, wherein at least one of said modules is of a first module type comprising at least one of said at least one hydraulic classifier.

14. The apparatus of claim 13, wherein said first module type comprises a plurality of hydraulic classifiers, preferably arranged in a row.

15. The apparatus of claim 13, wherein at least one of said modules is of a second module type comprising at least one of said at least one hydrocyclone, and preferably a plurality of hydrocyclones, preferably arranged in a row.

16. The apparatus of claim 15, including at least one instance of said second module type located on top of a respective module of said first module type.

17. The apparatus of claim 13, wherein at least one of said modules is of a third module type comprising at least one storage tank, and optionally a pump, wherein, typically, said at least one module of the third type is located below the or each module of the first type and of the second type when present.

18. The apparatus of claim 13, wherein at least one of said modules is of a fourth module type comprising at least one de-waterer.

19. The apparatus of claim 18, wherein said at least one module of the fourth type is located below the or each module of the first type and of a second type when present, the second type comprising at least one of said at least one hydrocyclone, and preferably a plurality of hydrocyclones, preferably arranged in a row.

20. The apparatus of claim 17, wherein at least one of said modules is of a fourth module type comprising at least one de-waterer, and wherein said at least one module of the fourth type and said at least one module of the third type are located side-by-side, preferably providing a base of the apparatus.

21. The apparatus of claim 13, wherein at least one of said modules is of a fifth module type comprising a control centre, and wherein, typically said at least one module of the fifth type is located below the or each module of the first type and of a second type when present, and preferably above the or each module of a third type and a fourth type when present.

22. The apparatus of claim 13, wherein said apparatus is a sand classification plant.

23. A particulate material classification plant comprising a material processing apparatus comprising a plurality of components including at least one material processing device and at least one ancillary component, the apparatus comprising a plurality of interconnectable modules, each module comprising a frame and at least one of said components carried by and located within the frame, wherein said frame is shaped and dimensioned to define a peripheral boundary of the module, said at least one of said components being located within said peripheral boundary.
